(19) United States
(12) Patent Application Publication
(10) Pub. No.: US 2006/0248778 A1
(43) Pub. Date: Nov. 9, 2006

(54) Apparatus for jigging fishing pole

(76) Inventors: Todd Ward, Sugar City, ID (US); Brent Parker, St. Anthony, ID (US)

Correspondence Address: RIGBY, THATCHER, ANDRUS, RIGBY& MOELLER, CHARTERED, P. O. BOX 250, 25 NORTH SECOND EAST, REXBURG, ID, 83440, US

(21) Appl. No.: 11/121,636

(22) Filed: May 3, 2005

(51) Int. Cl. A01K 97/10; A01K 91/06

(52) U.S. Cl. 43/19.2

(57) ABSTRACT

The invention is an apparatus for automated jigging of a fishing pole. The apparatus includes: a base connecting to a support surface, an arm pivotally connected to the base at a first connection area, a fishing pole engaging element pivotally connected to the arm at a second connection area and at an operator selected and operator modifiable angle, an assembly for selectively pivoting the arm around the first connection area with the base, an assembly for selectively and adjustably controlling a minimum elevation occupied by the second connection area. The apparatus may further include: an assembly for automatically disengaging the assembly for selectively pivoting the arm responsive to a downward force upon the fishing pole and an assembly for jerking a line portion of the fishing pole upward responsive to a downward force exerted by a fish upon the fishing pole.

### TECHNICAL FIELD

This invention relates to an apparatus for variable automated jigging of a fishing pole.

### BACKGROUND OF THE INVENTION

Processes for fishing with a fishing pole are well known. In typical practice an operator jigs for fish by moving bait, either live or artificial, upwardly and downwardly in the water for the purpose of attracting fish. Conventionally, jigging is accomplished by a human operator manually moving a fishing pole upwardly and downwardly in order to raise and lower the bait. In typical manual operation, the operator jigs through different distances and jigs with different frequencies and motions in an effort to best attract the fish to the bait.

To increase the likelihood of catching fish, particularly varieties of fish that tend to form schools, an operator may desire to set more than one fishing pole at a time. Since an operator can usually only manually jig a single fishing pole at a time, other fishing poles remain stationary and are not as effective in catching fish as a jigged fishing pole. In addition, an operator will often grow weary or uncomfortable during lengthy periods of manual jigging. Moreover, the elderly, children or those with physical disabilities may also struggle in attempting to manually jig, particularly for lengthy periods of time.

While several devices have been proposed for automatically oscillating bait attached to a fishing pole, such devices have various limitations. Many are comparatively complex and such complexity can potentially affect reliability as well as the ease and cost of operating, maintaining and repairing such devices. Many allow for continued oscillation, even after a fish hits the fishing line, thereby allowing slack in the fishing line and increasing the chance the hooked fish can become unhooked or break free.

Beyond the foregoing, many automated jigging devices do not allow an operator to modify the jigging distance, jigging frequency or jigging motion in an effort to better attract fish to the bait. Among those comparatively few devices that purport to allow for modification of jigging distance, jigging frequency or jigging motion, such modification generally requires removal of parts from, or addition of parts to the jigging device or the need to shut the device off during modification.

Further, many automated jigging devices do not specifically allow the operator to selectively adjust the dimensions of the automated jigging device to account for differing dimensions or weights of the fishing pole to be engaged or the fish to be fished. Yet further, many do not provide a structure or means for allowing the operator to orient the engaged fishing pole at an operator selected, operator modifiable angle determined by the operator to be best suited for the particular fishing conditions then existent. Yet even further, many do not provide easy access to the engaged fishing rod or a structure or means for rapidly and easily detaching the same from the jigging device.

While various devices include some of the general structural and operational features of the present invention, no previously known device includes the overall structural and functional features of the present invention. These structural and functional features promote efficiency, simplicity and ease of operation and allow the apparatus to (1) detachably connect with a fishing pole of variable dimensions, (2) hold the fishing pole during automated jigging at an operator selected and operator modifiable angle, (3) automatically jig the fishing pole an operator selected, operator modifiable vertical distance, and (4) provide a plurality of automated operator selected, operator modifiable settings allowing for a plurality of vertical movement phases of operator selected, operator modifiable duration with at least a stationary phase of operator selected, operator modifiable duration automatically interposed between sequential vertical movement phases. No previously known invention teaches a functional combination of elements like the present invention allowing for the performance of such a combination of functions.

Neither does any previously known invention contain the combination of the foregoing features of the present invention with either: (1) the present invention's assembly and means for automatically disengaging automated jigging in response to a downward force exerted by a fish upon the fishing pole; or (2) the present invention's assembly and means for jerking a line portion of the fishing pole upward in response to a downward force exerted by a fish upon the fishing pole.

### SUMMARY OF THE INVENTION

It is an object of this invention to provide an apparatus for automated jigging of a fishing pole. The apparatus includes: a base connectable to a support surface, an arm pivotally connected to the base at a first connection area, a fishing pole engaging element pivotally connected to the arm at a second connection area and at an operator selected, operator modifiable angle for orienting the fishing pole, an assembly for selectively and adjustably pivoting the arm around the first connection area with the base, and an assembly for selectively and adjustably controlling a minimum elevation occupied by the second connection area. In various preferred embodiments, the apparatus further includes: an assembly for automatically disengaging the assembly for pivoting the arm in response to a downward force exerted by a fish upon the fishing pole and an assembly for jerking a line portion of the fishing pole upward in response to a downward force exerted by a fish upon the fishing pole.

Another further object of this invention is to provide an apparatus in accordance with the preceding paragraph that automatically jigs a fishing pole an operator selected, operator modifiable vertical distance and provides a plurality of automated operator selected, operator modifiable settings allowing for a plurality of vertical movement phases of operator selected, operator modifiable duration with at least a stationary phase of operator selected, operator modifiable duration being automatically interposed between sequential vertical movement phases.

Another further object of this invention is to provide an apparatus in accordance with the preceding paragraphs allowing an operator to selectively adjust the total length of the arm to select an option the operator determines is best suited to the dimensions and weight of the fishing pole to be engaged and of the fish to be fished.

Another further object of this invention is to provide an apparatus in accordance with the preceding paragraphs performing the functions therein stated without removing parts from, or adding parts to the apparatus.

Another object of certain preferred embodiments of this invention is to provide a structure and means for selectively disengaging the automated structure and means for jigging the fishing pole when a downward force is exerted by a fish upon the engaged fishing pole.

Another object of certain preferred embodiments of this invention is to provide, particularly in combination with the other features of the invention, a structure and means for jerking a line portion of the fishing pole upward responsive to a downward force exerted by a fish upon the engaged fishing pole.

Another object of this invention is to provide the ease, convenience, flexibility and cost savings of an apparatus that is easily attachable to and modifiable for engagement with fishing poles of varying dimensions and varying weights without significant impact or damage to either the apparatus or the fishing pole engaged therewith and without undue expenditure of time or effort.

Another object of this invention is to provide an apparatus in accordance with the preceding objects which will conform to conventional forms of manufacture, be of comparatively simple construction and easy to use so as to provide a device that will be economically feasible, durable and relatively free of trouble in operation.

These together with the other objects and advantages of the invention which will become subsequently apparent reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a perspective view of the apparatus of the present invention.

FIG. 2 is an elevated left side plan view of the apparatus of the present invention shown attached to a portion of a fishing pole engaged therewith.

FIG. 3 is an elevated right side plan view of the apparatus of the present invention shown attached to a portion of a fishing pole engaged therewith.

FIG. 4 is an elevated front elevated plan view of the apparatus of the present invention shown attached to a portion of a fishing pole engaged therewith.

FIG. 5 is an elevated rear plan view of the apparatus of the present invention shown attached to a portion of a fishing pole engaged therewith.

FIG. 6 is an elevated plan view of the apparatus of the present invention shown attached to a portion of a fishing pole engaged therewith with an alternate position shown in phantom lines.

### DETAILED DESCRIPTION OF THE INVENTION

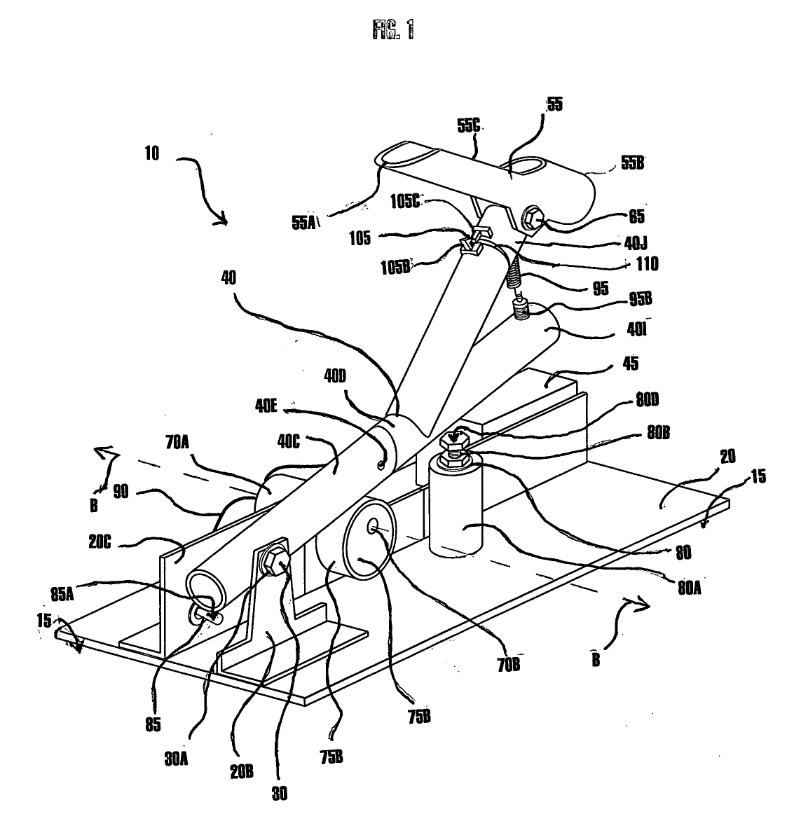

FIG. 1 illustrates in perspective view a preferred embodiment of an apparatus 10 for jigging a fishing pole. In standard operation, the apparatus 10 is operatively connected to a solid support surface, the support surface being a section of ice, a surface of a watercraft, a surface of a dock or another surface for supporting the apparatus during fishing, the support surface being referred to in general by numeral 15 in FIG. 1.

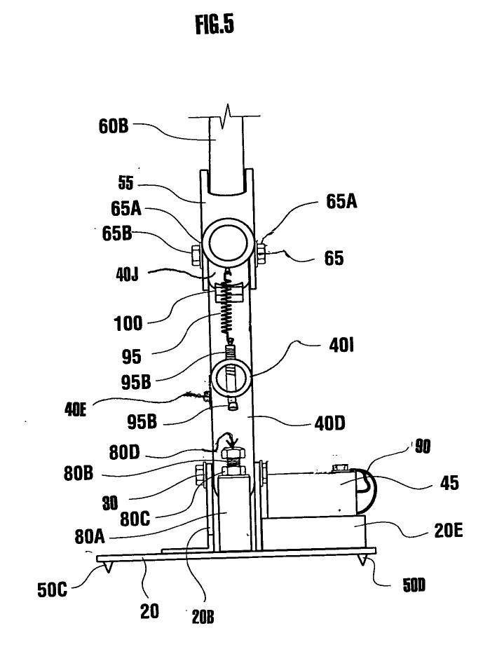

FIGS. 1, 2, 3, 4 and 5 illustrate a base 20 of a preferred embodiment of the apparatus 10, the base 20 having a bottom member 20A, a first arm retaining member 20B and a second arm retaining member 20C disposed parallel to the first arm retaining member 20B, the first arm retaining member 20B rigidly and perpendicularly connecting with the bottom member 20A at a first area 20G of the bottom member 20A and the second arm retaining member 20C rigidly and perpendicularly connecting with the bottom member 20A at a second area 20H of the bottom member 20A. In the preferred embodiment, each of the arm retaining members 20B, 20C has at least one aperture disposed therethrough with means for pivotally fastening an arm 40 to the base 20 being insertable through the apertures. In the particular embodiments shown the means for pivotally fastening include a threaded bolt 30A insertable through the aperatures one or more threaded nuts 30B rotatably connected to the bolt 30A and may additionally include one or more spacers 30C. It is to be appreciated that the means for pivotally fastening may alternatively include a pin, a rod, a tab and any other fastener for securely and pivotally connecting the base 20 to the arm 40.

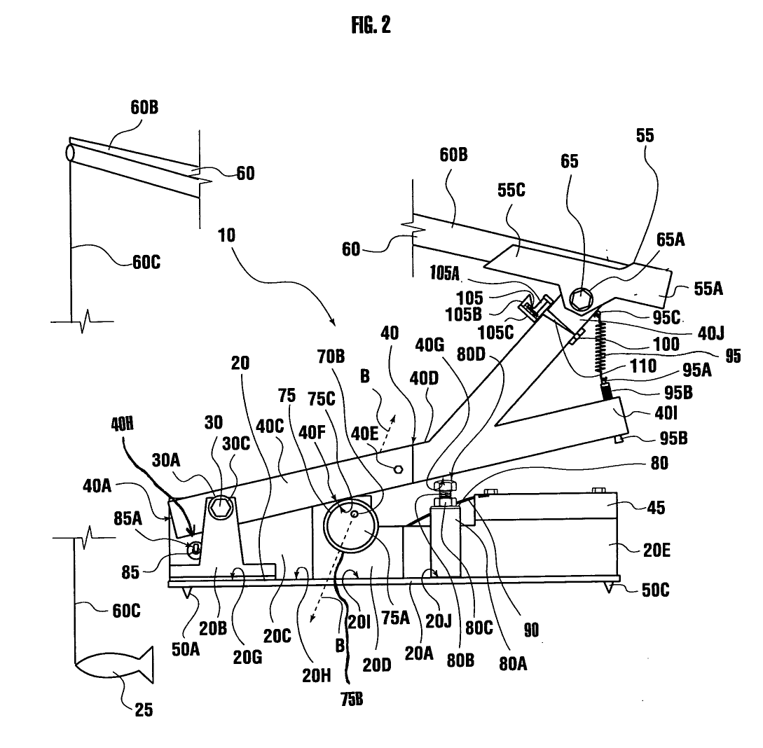

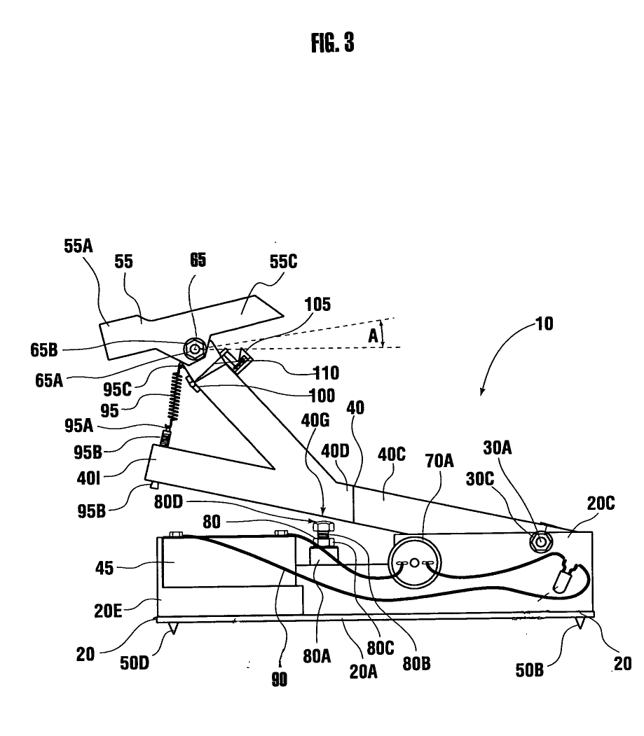

The base 20 of the embodiment shown in FIG. 2 may further include a pivot means support member 20D. In the embodiments shown in FIG. 2, the pivot means support member 20D rigidly connects with the bottom member 20A of the base 20 at a third area 20I of the bottom member 20A and, during standard operation, is disposed upward away from the rigid connection with the bottom member 20A to a distal end of the pivot means support member 20D. The base 20 may additionally include a power source retaining member 20E for supporting and retaining a power source 45 on the base 20. It is to be appreciated that the base 20 may be formed by rigidly connecting initially separate components or, alternatively, by manufacturing the base 20 as a single, integral piece of material (FIG. 3).

Referring to FIGS. 1, 2, 3, 4 and 5, the base 20 of the apparatus 10 operatively connects to the support surface 15 by means for securely connecting the base 20 to the source 15, the means for securely connecting comprising one or more base fasteners 50A, 50B, 50C, 50D. In the particular embodiments shown (FIGS. 2, 3, 4 and 5), each base fastener 50A, 50B, 50C, 50D is a spike for use on an ice surface, though the fasteners may include threaded screws insertable through apertures in the bottom member 20A of the base 20 and, alternatively, any other fastener for securely and detachably connecting the base 20 to the support surface 15.

Further shown in FIGS. 1, 2 and 3 is an arm 40, with a first arm end 40A and a second arm end opposite the first arm end 40A, the particular embodiment illustrated comprising a plurality of adjustable arm members, the plurality of adjustable arm members including a least a tubular first arm member 40C and a second arm member 40D, the second arm member 40D being slidingly insertable into an internal passageway within the first arm member 40C and thereby allowing an operator to selectively adjust total length of the arm 40. Once a desired total arm length is selected, the length is held constant by means for locking, the means for locking shown in the particular embodiment shown in FIGS. 1 and 2 comprising a locking screw 40E rotatably insertable in a threaded passageway, the threaded passageway extending through a side of the first arm member 40C into an internal passageway containing a portion of the second arm member 40D. When tightened, the locking screw 40E presses against the second arm member 40D thereby holding the second arm member 40D in place and the total length of the arm 40 constant. It is, however, to be appreciated that non-adjustable embodiments of the arm 40 can be formed from a single, integral piece of rigid material.

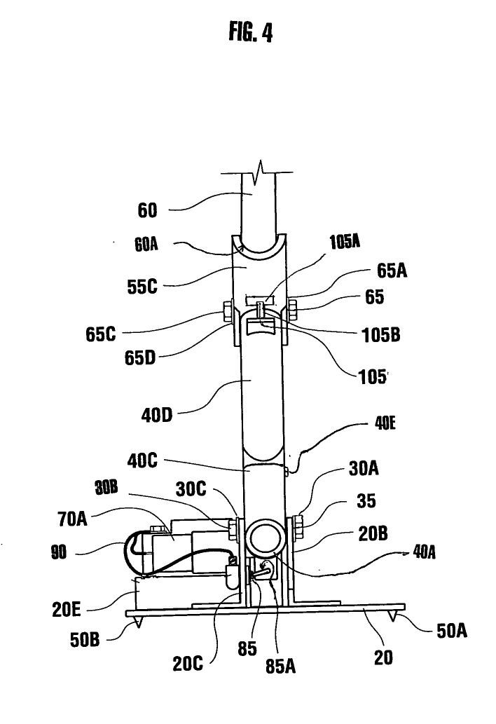

Further shown in FIGS. 1, 2, 3, 4 and 5 is a fishing pole engaging element 55 with an opening 55A (FIG. 1) and a fishing pole retaining sleeve 55B for receiving and detachably retaining a terminal end 60A (FIG. 4) of a fishing pole 60 therein. The fishing pole engaging element 55 may also include a cradle portion 55C to further support and stabilize the engaged fishing pole 60. The fishing pole engaging element 55 securely, pivotally, and adjustably connects to the arm 40 at a second connection area 65 at an operator selected, operator modifiable first angle A (FIG. 3) for orienting the fishing pole engaging element 55 together with a rod portion 60B of the fishing pole 60 by means for securely, pivotally and adjustably fastening. In the particular embodiment shown in FIGS. 2 and 3, the means for securely, pivotally and adjustably fastening the fishing pole engaging element 55 include a second threaded bolt 65A and one or more threaded nuts 65B rotatably connected thereto. It is to be appreciated that the means for securely, pivotably and adjustably fastening may alternatively include any other fastener for securely, pivotally and adjustably connecting the fishing pole engaging element 55 with the arm 40 at a operator selected, operator modifiable first angle A.

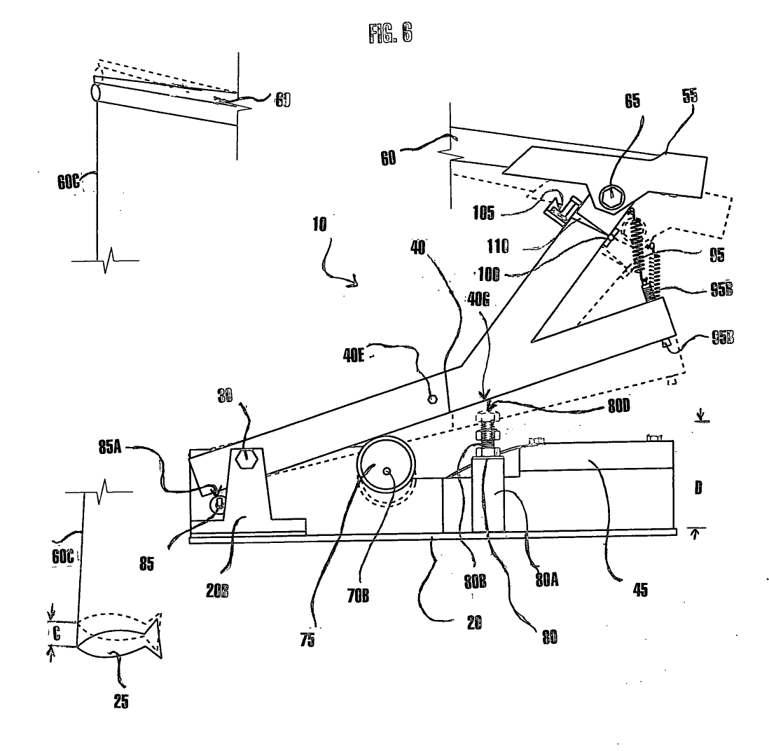

As seen in FIGS. 1, 2, 3, 5 and 6, the arm 40 of the apparatus 10 operatively connects to means for selectively pivoting the arm 40 around the first connection area 30 with the base 20. In a preferred embodiments, the means for selectively pivoting the arm 40 include: (1) a motor 70A (FIGS. 1 and 3) mounted on the base 20, the motor 70A operatively connecting to a power source 45 and operatively connecting to a drive shaft 70B, and (2) a motion imparting element 75 (FIGS. 1, 2, 5 and 6) eccentrically mounted to the drive shaft 70B. In standard operation, the motor 70A uses power supplied by the power source 45 to rotate the motion imparting element 75 in an orbit about an axis B (FIG. 1) formed through a centerline of the drive shaft 70B. As the motion imparting element 75 rotates around the drive shaft 70B, a first contact surface 75C along the upper portion of the motion imparting element 75 contacts a second contact surface 40F on the arm 40, partially pivoting the arm 40 and the attached fishing pole engaging element 55 around the first connection area 30 between the arm 40 and the base 20 and thereby jigs upwardly and downwardly the engaged fishing pole 60, including the rod portion 60B and line portion 60C thereof. In a preferred embodiment, the arm 40 is held in contact with the motion imparting element 75 by gravity. A preferred power source 45 shown in FIGS. 2 and 6 is a battery.

In a preferred embodiment shown in FIGS. 1 and 2 the motion imparting element 75 includes an inner portion 75A and an outer portion 75B, the outer portion 75B operatively and rotationally connecting to the inner portion 75A via a plurality of bearings (not shown) so as to maintain contact between the first contact surface 75C of the motion imparting element 75 and the arm 40 as the inner portion 75A of the motion imparting element 75 rotates around the axis B (FIG. 1) formed through the centerline of the drive shaft 70B.

With attention directed to FIGS. 1, 2, 3, 5 and 6, it is also seen that the apparatus 10 includes means for selectively and adjustably controlling a minimum elevation occupied by the second connection area 65, the means for selectively and adjustably controlling a minimum elevation on the preferred embodiment shown including an elevation control assembly 80 rigidly connecting with the bottom member 20A of the base 20 at a fourth area 20J, the elevation control assembly 80 being more distally located from the first connection area 30 than from the motion imparting element 75. In the preferred embodiment shown, the elevation control assembly 80 includes (1) a sleeve member 80A, and (2) an insert member 80B, the insert member 80B being insertable in the sleeve member 80A to an operator selected and operator modifiable depth and allowing an operator to thereby select and adjust the total height D (FIG. 6) of the elevation control assembly 80. In the particular embodiment shown in FIGS. 1 and 2 the sleeve member 80A includes a threaded engaging nut 80C rigidly attached to the remaining portion of the sleeve member 80A and the insert member 80B comprises a threaded bolt rotatably inserted through the engaging nut 80C to set the elevation control assembly 80 to an operator selected and operator modifiable height.

In standard operation, a fourth contact surface 80D on the elevation control assembly 80 lies beneath a third contact surface 40G on the arm 40, and the height of the elevation control assembly 80 may be modified (FIG. 6) causing the fourth contact surface 80D on the elevation control assembly 80 to contact the third contact surface 40G on the arm 40. The elevation control assembly 80 may thus support the arm 40 and set the second connection area 65 between the arm 40 and the fishing pole engaging element 55 at an operator controlled, operator selected minimum elevation.

By setting the total height of the elevation control assembly 80 to a height such that the fourth contact surface 80D occupies an elevation above a minimum elevation the third contact surface 40G of the arm 40 would occupy absent contact with the elevation control assembly 80, the operator can: (1) selectively and adjustably control a minimum elevation occupied by the second connection area 65; (2) selectively modify both the vertical distance C (FIG. 6) the fishing pole 60 (including line portion 60C) is jigged and (3) select a stationary phase of operator selected, operator modifiable duration between each vertical movement phase of the fishing pole 60 as the motion imparting element 75 rotates around the drive shaft 70B contacting the second contact surface 40F on the arm 40, partially pivoting the arm 40 and the attached fishing pole 60 up and down around the first connection area 30 between the arm 40 and the base 20. The apparatus 10 may thus provide a plurality of operator selected, operator modifiable settings for automatically jigging the fishing pole 60 wherein: (1) settings among the plurality of settings include at least a vertical movement phase of operator selected, operator modifiable first duration and a stationary phase of operator selected, operator modifiable second duration, and (2) the first duration and the second duration are selected and modifiable by an operator by modifying the height of the elevation control assembly 80 and without addition to, or removal of parts from the apparatus 10.

As seen in FIGS. 1, 2, 4 and 6, the base 20 may also include a disengaging means support member 20F to support means for automatically disengaging the means for selectively pivoting in response to a downward force exerted by a fish 25 upon the fishing pole 60. In the embodiment shown, the means for automatically disengaging the means for selectively pivoting the arm 40 include (1) a toggle switch 85 mounted upon the disengaging means support member 20F of the base 20, and (2) a relay 90 operatively connecting the toggle switch 85 to the motor 70A and to the power source 45. When sufficient downward force is exerted upon the fishing pole 60 to sufficiently pivot the arm 40 around the first connection area 30, an arm contact surface 40H (FIG. 2)located more distally from the second connection area 65 than from the motion imparting element 75 moves as the arm 40 pivots around the first connection area 30 and contacts a switch contact surface 85A of the toggle switch 85 forcing the switch contact surface 85A and toggle switch 85 downward into an off position disengaging the motor 70A and ceasing automated jigging of the arm 40, the fishing pole engaging element 55 and the attached fishing pole 60 with line portion 60C.

As seen in FIGS. 1, 2, 3 and 6 the apparatus 10 may additionally include means for jerking the line portion 60C of the fishing pole 60 upward responsive to a downward force exerted upon the fishing pole 60, as in the case of a downward force exerted by a fish 25, the means for jerking in a preferred embodiment shown including a jerking assembly comprising: (1) a spring element 95 adjustably and operatively connecting at a first spring end 95A to a tension adjustment member 95B, the tension adjustment member 95B connecting to a platform portion 40I of the arm 40 and the spring element 95 operatively connecting at a second spring end 95C to an upper portion 40J of the arm 40; (2) a hinge 100 pivotally connecting the upper portion 40J of the arm 40 to a remainder of the arm 40, (the remainder of the arm 40 including that portion of the arm other than the upper portion 40J of the arm 40); (3) a detachable connection sub-assembly 105 connecting the upper portion 40J of the arm 40 to the remainder of the arm 40; and (4) a compressible resilient pad 110 operatively connected to and disposed between the upper portion 40J of the arm 40 and the remainder of the arm 40. In a preferred embodiment shown (FIGS. 1 and 2), the platform portion 40I is located more distally from the first connection area 30 than from the motion imparting element 75.

In a preferred embodiment best seen in FIGS. 1, 2 and 3, the detachable connection sub-assembly 105 includes a latch 105A and a hook 105B detachably connecting to the latch 105A. When sufficient downward force is exerted upon the fishing pole 60—as in the circumstance a fish 25 tugs on the line 60C—the force generated thereby against the compressible resilient pad 110, compresses the pad 110, moving the hook 105B relative to the latch 105A, unlatching the hook 105B from the latch 105A and allowing the spring element 95 to jerk an upper portion 40J of the arm 40 pivotally around the hinge 100 and toward the platform portion 40I of the arm 40, thereby jerking the line portion 60C of the fishing pole 60 upward. To further facilitate unlatching of the hook 105B from the latch 105A, the detachable connection sub-assembly 105 may be tensioned. In the embodiment shown in FIGS. 2 and 3 a compressed spring 105C, provides force upon the hook 105B and thereby aids in facilitating unlatching of the hook 105B from the latch 105A when the compressible resilient pad 110 is compressed.

The foregoing is considered as illustrative only of the principles of the invention. Further, since modifications and changes will occur to those skilled in the art, it is not desired to limit the invention to the exact construction and operation shown and described, and, accordingly, all suitable modifications and equivalents may be resorted to, falling within the scope of the invention. In addition to materials noted in the preceding paragraphs of this detailed description of the invention, the materials used in construction of the invention are metallic elements, metallic alloys, and polymers which provide strength, durability and impart rust resistance.

What is claimed is:

1. An apparatus for automated jigging of a fishing pole, said apparatus comprising:
a) a base, said base operatively and detachably connecting to a support surface;
b) a fishing pole engaging and supporting assembly including:
i) an arm, said arm pivotally and operatively connecting to said base at a first connection area;
ii) a fishing pole engaging element pivotally and operatively connecting to said arm at a second connection area and at an operator selected and operator modifiable first angle, said engaging element operatively and detachably connecting to said fishing pole;
c) means for selectively pivoting said arm around said first connection area with said base;
d) means for selectively and adjustably controlling a minimum elevation occupied by said second connection area;
wherein said apparatus automatically jigs said fishing pole an operator selected, operator modifiable vertical distance; and
wherein said apparatus provides a plurality of operator selected, operator modifiable settings for automatically jigging said fishing pole and a setting among said plurality of settings provides a vertical movement phase of operator selected, operator modifiable first duration and a stationary phase of operator selected, operator modifiable second duration, said first duration and said second duration being selected and modifiable without addition or removal of parts from said apparatus.

2. An apparatus as in claim 1 wherein said means for selectively and adjustably controlling said minimum elevation occupied by said second connection area include an elevation control assembly of operator selected, operator modifiable height, said elevation control assembly comprising:
a) a sleeve member; and
b) an insert member insertable in said sleeve member.

3. An apparatus as in claim 1 wherein said means for selectively pivoting said arm around said first connection area with said base comprise:
a) a motor mounted on said base and operatively connected to a power source, said motor operatively connecting to a drive shaft; and
b) a motion imparting element eccentrically mounted to said drive shaft.

4. An apparatus as in claim 3 wherein said motion imparting element comprises an inner portion and an outer portion, said outer portion operatively and rotationally connecting to said inner portion.

5. An apparatus as in claim 1 wherein said arm comprises a plurality of selectively adjustable arm members for selectively adjusting a total length of said arm.

6. An apparatus for automated jigging of a fishing pole, said apparatus comprising:
a) a base, said base operatively and detachably connecting to a support surface;
b) a fishing pole engaging and supporting assembly including:
i) an arm, said arm pivotally and operatively connecting to said base at a first connection area;
ii) a fishing pole engaging element pivotally and operatively connecting to said arm at a second connection area and at an operator selected and operator modifiable first angle, said engaging element operatively and detachably connecting to said fishing pole;
c) means for selectively pivoting said arm around said first connection area with said base;
d) means for selectively and adjustably controlling a minimum elevation occupied by said second connection area; and
e) means for automatically disengaging said means for selectively pivoting said arm responsive to a downward force exerted by a fish upon said fishing pole.

7. An apparatus as in claim 6 wherein wherein said arm comprises a plurality of selectively adjustable arm members for selectively adjusting a total length of said arm.

8. An apparatus as in claim 6 wherein said means for selectively and adjustably controlling said minimum elevation occupied by said second connection area include an elevation control assembly of operator selected, operator modifiable height, said elevation control assembly comprising:
a) a sleeve member; and
b) an insert member insertable in said sleeve member.

9. An apparatus as in claim 6 wherein said means for selectively pivoting said arm around said first connection area with said base comprise:
a) a motor mounted on said base and operatively connected to a power source, said motor operatively connecting to a drive shaft; and
b) a motion imparting element eccentrically mounted to said drive shaft.

10. An apparatus as in claim 9 wherein said motion imparting element comprises an inner portion and an outer portion, said outer portion operatively and rotationally connecting to said inner portion.

11. An apparatus as in claim 9 wherein said means for automatically disengaging said means for selectively pivoting said arm comprise a toggle switch mounted upon said base, said toggle switch having a switch contact surface thereon and being operatively connected to said motor, wherein an arm contact surface located more distally from said second connection area than from said motion imparting element, in response to downward force exerted by said fish upon said fishing pole, moves as said arm pivots around said first connection area and thereby contacts said switch contact surface forcing said switch downward disengaging said motor.

12. An apparatus for automated jigging of a fishing pole, said apparatus comprising:
a) a base, said base operatively and detachably connecting to a support surface;
b) a fishing pole engaging and supporting assembly including:
i) an arm, said arm pivotally and operatively connecting to said base at a first connection area;
ii) a fishing pole engaging element pivotally and operatively connecting to said arm at a second connection area and at an operator selected and operator modifiable first angle, said engaging element operatively and detachably connecting to said fishing pole;
c) means for selectively pivoting said arm around said first connection area with said base;
d) means for selectively and adjustably controlling a minimum elevation occupied by said second connection area;
e) means for automatically disengaging said means for selectively pivoting said arm responsive to a downward force exerted by a fish upon said fishing pole; and
f) means for jerking a line portion of said fishing pole upward responsive to a downward force exerted by a fish upon said fishing pole.

13. An apparatus as in claim 12 wherein said arm comprises a plurality of selectively adjustable arm members for selectively adjusting a total length of said arm.

14. An apparatus as in claim 12 wherein said means for selectively and adjustably controlling said minimum elevation occupied by said second connection area include an elevation control assembly of operator selected, operator modifiable height, said elevation control assembly comprising:
a) a sleeve member; and
b) an insert member insertable in said sleeve member.

15. An apparatus as in claim 12 wherein said means for selectively pivoting said arm around said first connection area with said base comprise:
a) a motor mounted on said base and operatively connected to a power source, said motor operatively connecting to a drive shaft; and
b) a motion imparting element eccentrically mounted to said drive shaft.

16. An apparatus as in claim 15 wherein said motion imparting element comprises an inner portion and an outer portion, said outer portion operatively and rotationally connecting to said inner portion.

17. An apparatus as in claim 15 wherein said means for automatically disengaging said means for selectively pivoting said arm comprise a toggle switch mounted upon said base, said toggle switch having a switch contact surface thereon and being operatively connected to said motor, wherein an arm contact surface located more distally from said second connection area than from said motion imparting element, in response to downward force exerted by said fish upon said fishing pole, moves as said arm pivots around said first connection area and thereby contacts said switch contact surface forcing said switch downward disengaging said motor.

18. An apparatus as in claim 12 wherein said means for jerking said line portion of said fishing pole upward include a jerking assembly, said jerking assembly comprising:
a) a tension adjustment member operatively and adjustably connecting to a platform portion of said arm;
b) a spring element operatively connecting at a first spring end to said tension adjustment member, said spring element operatively connecting at a second spring end opposite said first spring end to an upper portion of said arm;
c) a hinge pivotally connecting said upper portion of said arm to remainder of said arm;
d) a detachable connection sub-assembly detachably connecting said upper portion of said arm to remainder of said arm; and
e) a compressible resilient pad operatively connected to and disposed between said upper portion of said arm and said remainder of said arm.
